(19) United States
(12) Patent Application Publication
(10) Pub. No.: US 2010/0151888 A1
(43) Pub. Date: Jun. 17, 2010

(54) METHOD AND SYSTEM FOR TRANSMITTING AND RECEIVING MULTIMEDIA MESSAGE

(75) Inventor: Jong Eun BAEK, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/630,921

(22) Filed: Dec. 4, 2009

(30) Foreign Application Priority Data
Dec. 11, 2008 (KR) 10-2008-0125912

(51) Int. Cl. H04W 4/12

(52) U.S. Cl. 455/466

(57) ABSTRACT

A method and a system for transmitting and receiving a multimedia message are disclosed. The system includes a mobile terminal on which a user views a preview of the contents of an MMS message without reception of the entire MMS message. The preview message is based on the type and content of the message. The entire MMS message may be then be provided upon the user's request.

### CLAIM OF PRIORITY

This application claims the benefit of the earlier filing date, pursuant to 35 UCS 119, to that patent application entitled “METHOD AND SYSTEM FOR TRANSMITTING AND RECEIVING MULTIMEDIA MESSAGE” filed in the Korean Intellectual Property Office on Dec. 11, 2008 and assigned Serial No. 10-2008-0125912, the contents of which are incorporated herein by reference.

### BACKGROUND OF THE INVENTION

1. Field of the Invention

The present invention relates to the field of multimedia messaging and, more particularly, to a method and a system for reconstructing a multimedia message service (MMS) message to be sent to a mobile terminal such that the mobile terminal receives the reconstructed message.

2. Description of the Related Art

With recent rapid widespread of mobile terminals, mobile terminals have become a modern necessity of life. As such, the mobile terminals not only provide voice communication services but also various data transmission and supplementary services such that the mobile terminals have become multimedia communication devices in view of the many functions that they now perform.

Generally, the mobile terminal is now being widely used not only for voice communication but also for a short message service (SMS) that allows messages to be sent regardless of operating status of a receiver mobile terminal. The SMS is a wireless call service allowing a caller to easily send the caller's statements to a receiver mobile terminal at low cost regardless of the communication status of the caller mobile terminal. Moreover, with recent increase of data transfer rate, the use of a multimedia messaging service (MMS) allowing to transmit and receive different kinds of data, such as lengthy text, voice, music, still image, and a moving picture, as well as a short message increases.

A user of a motion control camera, when a multimedia message (hereinafter, referred to as ‘MMS message’) is received, may set his/her mobile terminal to automatically receive the MMS message or to selectively receive the MMS message. However, the user cannot preview contents and size of a file included in the MMS message, but must receive the entire MMS message in order to check these message parameters. In this case, the user may be forced to pay unnecessary fees or unnecessary data may be stored in a memory of the mobile terminal. Therefore, there is a need for a method of checking the contents of an MMS message without having to receive the entire MMS message and determining whether to receive the entire MMS message.

### SUMMARY OF THE INVENTION

The present invention provides a multimedia message transmitting and receiving method and system enabling a user of a mobile terminal to check the contents of an MMS message without having to receive the entire MMS message and to determine whether to receive the entire MMS message.

In accordance with an exemplary embodiment of the present invention, there is provided a method of transmitting and receiving a multimedia message including: transmitting, by a multimedia messaging service (MMS) server, a notification message notifying of an arrival of an MMS message from the MMS server to an MMS receiver terminal when the MMS server receives at least one MMS message from a MMS sender terminal; requesting, by the MMS receiver terminal, the MMS server to transmit a preview MMS message; converting by the MMS server the MMS message received from the MMS sender terminal into the preview MMS message; and transmitting by the MMS server the converted MMS message to the MMS receiver terminal.

In accordance with another exemplary embodiment of the present invention, there is provided a method of transmitting and receiving a multimedia message including: starting conversion of a multimedia messaging service (MMS) message received from an MMS sender terminal into a preview MMS message by an MMS server when at least one MMS messages is received from the MMS sender terminal; transmitting a notification message notifying of an arrival of the MMS message to an MMS receiver terminal by the MMS server; requesting the MMS server to transmit the preview MMS message by the MMS receiver terminal; and transmitting the converted preview MMS message to the MMS receiver terminal by the MMS server.

In accordance with another exemplary embodiment of the present invention, there is provided a multimedia message transmitting and receiving system including: a multimedia messaging service (MMS) terminal requesting transmission of an MMS message; an MMS receiver terminal receiving the MMS message; and an MMS server converting the MMS message received from the MMS sender terminal into a preview MMS message and transmitting the converted preview MMS message to the MMS receiver terminal when a request for the transmission of the MMS message is received from the MMS sender terminal.

In a feature of the present invention, a mobile terminal user views the contents of an MMS message without reception of the entire MMS message so that the user does not need to pay fees for viewing the MMS message and undesired data can be prevented from being stored in a memory of the mobile terminal.

### BRIEF DESCRIPTION OF THE DRAWINGS

The features and advantages of the present invention will be more apparent from the following detailed description in conjunction with the accompanying drawings, in which:

FIG. 1 is a schematic view illustrating a configuration of a multimedia transmitting and receiving system according to an exemplary embodiment of the present invention;

FIG. 2 is a block diagram illustrating a multimedia messaging service (MMS) receiver terminal employed in the multimedia transmitting and receiving system according to the exemplary embodiment of the present invention;

FIG. 3 is a sequence diagram illustrating a multimedia message transmitting and receiving method according to an exemplary embodiment of the present invention;

FIG. 4 is a sequence diagram illustrating a multimedia message transmitting and receiving method according to another exemplary embodiment of the present invention;

FIG. 5 is a sequence diagram illustrating a multimedia message transmitting and receiving method according to still another embodiment of the present invention; and

FIG. 6 is a sequence diagram illustrating a multimedia message transmitting and receiving method according to still another exemplary embodiment of the present invention.

### DETAILED DESCRIPTION OF THE INVENTION

In this description, the term ‘preview multimedia messaging service (MMS) message’ refers to a message obtained by transforming an original MMS message received by an MMS server from an MMS sender terminal and having a smaller size than that of the original MMS message.

The term ‘original MMS message’ refers to an MMS message including all data which the MMS sender terminal will send. The original MMS message may be an original MMS message received by the MMS server from the MMS sender terminal or an original MMS message for transmission transmitted to an MMS target terminal by the MMS server. The MMS server decodes the received original MMS message and encodes the decoded original MMS message into the original MMS message for transmission. The MMS server transmits the original MMS message for transmission to the MMS receiver terminal.

Exemplary embodiments of the present invention are described in detail with reference to the accompanying drawings. For the purposes of clarity and simplicity, detailed descriptions of well-known functions and structures incorporated herein may be omitted to avoid obscuring the subject matter of the present invention. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

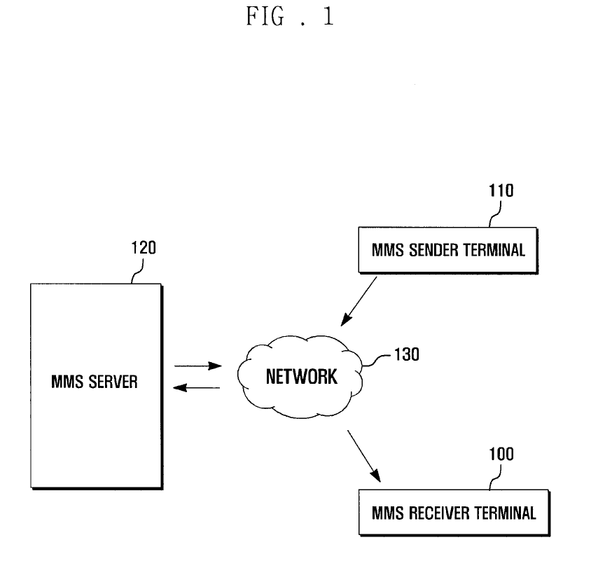

FIG. 1 is a schematic view illustrating configuration of a multimedia transmitting and receiving system according to an exemplary embodiment of the present invention.

A multimedia message transmitting and receiving system according to an exemplary embodiment of the present invention includes an MMS receiver terminal 100, an MMS sender terminal 110, and an MMS server 120. The MMS receiver terminal 100, the MMS sender terminal 110, and the MMS server 120 are connected to each other through a wired or wireless communication network 130. The wired or wireless communication network 130 includes a communication network connected by telephone lines, coaxial cables, optical fibers, and the like, a wireless communication network, a packet switched network (PSN), an integrated services digital network (ISDN), and a broadband integrated services digital network (B-ISDN).

The MMS receiver terminal 100 receives an MMS message from the MMS server 120. The MMS receiver terminal 100 may perform wired and wireless communication with the MMS server 120 and may be one of a digital broadcasting terminal, a personal digital assistant (PDA), a smart phone, an international mobile telecommunication 2000 (IMT-2000) terminal, a wideband code division multiple access (WCDMA) terminal, and a universal mobile telecommunication service (UMTS) terminal. The MMS receiver terminal 100 receives a notification message indicating arrival of an MMS message from the MMS server 120 substantially before reception of the MMS message. The notification message includes a caller's telephone number, a message ID, and header information of the MMS message.

The MMS receiver terminal 100 may set an MMS receiving mode. The MMS receiving mode includes an immediate retrieval mode, a deferred retrieval mode, and a preview retrieval mode. A user of the MMS receiver terminal 100 may set the MMS mode to receive the MMS message. In the immediate retrieval mode, when the MMS receiver terminal 100 receives the notification message from the MMS server 120, the MMS receiver terminal 100 immediately requests that the MMS server 120 transmit an MMS message. The notification message may be transmitted in the form of a short message service. In the deferred retrieval mode, when the MMS receiver terminal 100 receives the notification message from the MMS server 120, the MMS receiver terminal 100 transmits a response for the notification message to the MMS server 120. A user of the MMS receiving server 100 selects whether to receive an original MMS message and provides their decision to the MMS server 120. In the preview retrieval mode, when the MMS receiver terminal 100 receives the notification message from the MMS server 120, the MMS receiver terminal 100 transmits a response to the notification message to the MMS server 120 and informs the MMS server 120 of the user's decision as to whether to receive a preview MMS message or not.

The MMS sender terminal 110 generates an MMS message to be sent to the MMS receiver terminal 100 and transmits the MMS message to the MMS server 120. The MMS sender terminal 110 is a communication terminal to transmit the MMS message to the MMS server 120 and may be one of a mobile terminal, a personal computer, a desktop computer, a laptop computer, and the like. When the MMS sender terminal 110 is a mobile terminal, the MMS sender terminal 110 transmits the MMS message to the MMS server 120 via a wireless communication network. When the MMS sender terminal 110 is a computer, the MMS sender terminal 110 accesses the MMS server 120 via an internet network. In this case, a user of the MMS sender terminal 110 may access a web site providing predetermined messages to select an MMS message to be sent. The selected MMS message may be transmitted to the MMS server 120 and the MMS server 120 may transmit the transmitted MMS message to the MMS receiver terminal 100.

Synchronized multimedia integration language (SMIL), which is an MMS standard markup language, is employed in creating the MMS message. The SMIL may be defined as ‘an integrated language for multimedia having several simple tags and properties’ or ‘a multimedia layout language proposed by the World Wide Web consortium (W3C)’. SMIL is a language defining standards necessary for expressing synchronized multimedia content such as sound, moving pictures, and text and a transmission technique thereof.

The MMS server 120 breaks from basic services concentrated on voice messages and SMS messages and provides a message service for transmitting and receiving messages including internet e-mail at any place and allowing any type of multimedia messages. The MMS server 120 transmits an original MMS message received from the MMS sender terminal 110 to the MMS receiver terminal 100. The MMS server 120 converts the original MMS message received from the MMS sender terminal into a preview MMS message or an original MMS message for transmission according to setting conditions of the MMS receiver terminal 100. The MMS server 120 transmits the preview MMS message or the original MMS message to the MMS receiver terminal 100 in response to the request from the MMS receiver terminal 100.

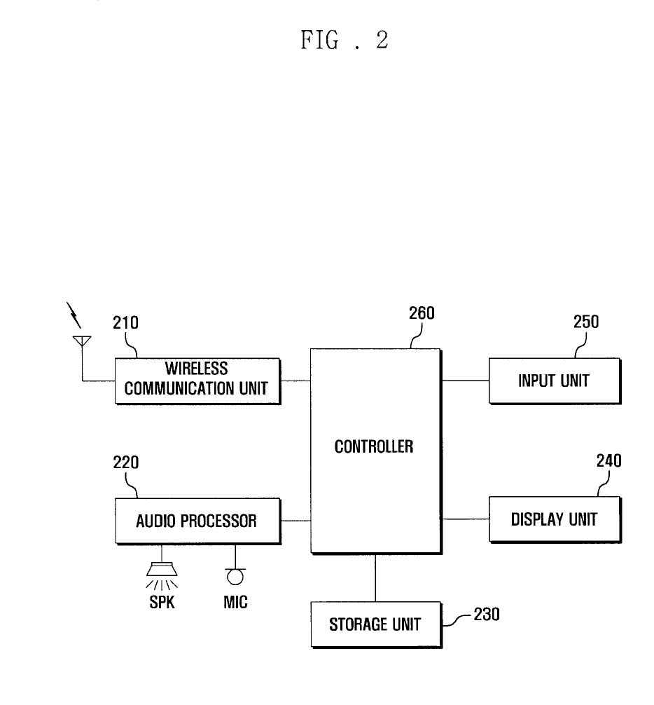

FIG. 2 shows a configuration of the MMS receiver terminal 100 employed in the exemplary embodiment of the present invention.

As illustrated in FIG. 2, the MMS receiver terminal 100 includes a wireless communication unit 210 performing wireless communication, an audio processor 220 processing audio signals, a storage unit 230 storing programs and data, a display unit 240 displaying various types of information, an input unit 250 through which commands for controlling the MMS receiver terminal 100, and a controller 260 controlling overall operation of the MMS receiver terminal 100.

The wireless communication unit 210 performs transmission and reception of data for wireless communication of the MMS receiver terminal 100. The wireless communication unit 210 may include an RF transmitter up-converting and amplifying frequency of a transmitted signal and an RF receiver low-noise-amplifying a received signal and down-converting frequency of the received signal. The wireless communication unit 210 may receive data through a wireless channel to output the data to the controller 260 and may transmit the data output from the controller 260 through the wireless channel. The wireless communication unit 210 receives the MMS message from the MMS server 120 under the control of the controller 260. The wireless communication unit 210 communicates with a base station (not shown) and the base station receives the MMS message from the MMS server 120 through the wired and wireless network.

The audio processor 220 may include a codec, wherein the codec includes a data codec to process packet data and an audio codec to process audio signals, such as voice. The audio processor 220 converts a digital audio signal into an analog audio signal using the audio codec to reproduce the converted audio signal through a speaker SPK, and converts an analog audio signal input from a microphone MIC into a digital audio signal using the audio codec. The audio processor 220 may output a sound informing a user of the arrival of a notification message when the notification message notifying of the arrival of an MMS message from the MMS server 120 is received. When the controller 260 displays a message for selecting transmission of the original MMS message or the preview MMS message on the display 240, the audio processor 220 may output a sound effect corresponding to the selection message. The audio processor 220 outputs audio data contained in the preview MMS message or the original MMS message.

The storage unit 230 stores programs and data required for the operation of the MMS receiver terminal 100 and may be divided into a program region and a data region. The storage unit 230 stores setting information in an MMS receiving mode. The MMS receiving mode includes an immediate retrieval mode, a deferred retrieval mode, and a preview retrieval mode. When the user of the MMS receiver terminal 100 sets the MMS receiving mode, the controller 260 controls the storage unit 230 to store the setting information of the MMS receiving mode. After that, when the wireless communication unit 210 receives the notification message notifying of the arrival of the MMS message from the MMS server 120, the controller 260 requests the MMS server 120 to transmit the MMS message by referring to the setting information of the MMS receiving mode that is stored in the storage unit 230.

The display unit 240 may be a liquid crystal display (LCD) and visually provides a menu of the MMS receiver terminal 100, input data, function setting information, and other various kinds of information to a user of the MMS receiving terminal 100. For example, the display unit 240 outputs a boot screen of the MMS receiver terminal 100, an idle screen, a display screen, a dialing screen, and other application execution screens. The display unit 240 displays a setting menu provided to set the MMS receiving mode. The MMS receiving mode setting menu may be included in an existing menu of the MMS receiver terminal 100 or in a user-setting menu. In this exemplary embodiment, when the controller 260 receives the notification message informing of the arrival of the MMS message through the wireless communication unit 210, the display unit 240 may display a message allowing the user to select any one of: reception of the original MMS message, reception of the preview retrieval MMS message, and MMS message rejection. The display unit 240 displays a moving picture contained in the received preview MMS message or the original MMS message.

The input unit 250 receives key inputs, input by the user, to control the MMS receiver terminal 100 and transmits the same to the controller 260. The input unit 250 may be a keypad including alphanumeric keys and arrow keys or may be coupled with the display unit 240 when the display unit 240 is a touch screen. In this exemplary embodiment, the user of the MMS receiver terminal 100 may set the MMS receiving mode through the input unit 250. In this exemplary embodiment of the present invention, when the display unit 240 displays the message allowing the user to select any one of the original MMS message reception, the preview MMS message reception, and the MMS message rejection, the user may select any one of the displayed messages through the input unit 250.

The controller 260 controls overall operation of the MMS receiver terminal 100 and signal flows between internal functional blocks of the MMS receiver terminal 100. The controller 260 sets the MMS receiving mode. When the user selects the MMS setting mode, the controller 260 controls the display unit 240 to display the MMS receiving mode setting menu. When the user inputs a key for setting the MMS receiving mode setting through the input unit 250, the controller 260 receives the key input signal from the input unit 250 and stores the MMS receiving mode information in the storage unit 230. The controller 260 controls the wireless communication unit 210 to receive the notification message from the MMS server 120 and requests the MMS server 120 to transmit the MMS message.

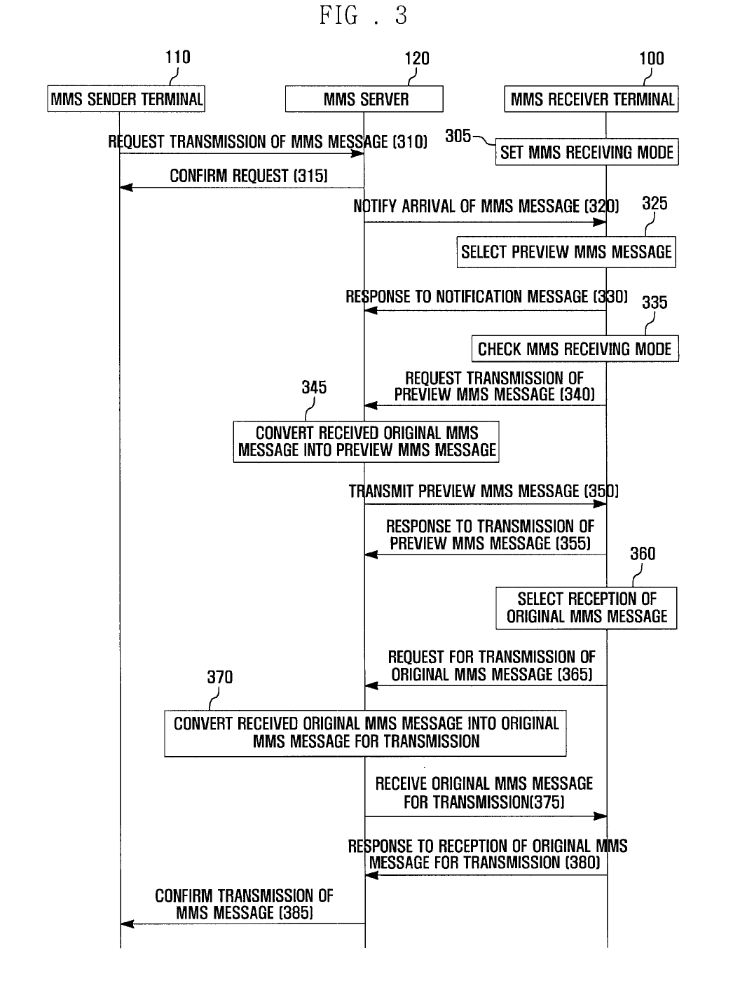

FIG. 3 shows a sequence diagram illustrating a multimedia message transmitting and receiving method according to an exemplary embodiment of the present invention.

The MMS receiver terminal 100 sets the MMS receiving mode (305). The MMS receiving mode setting menu may be included with an existing menu of the MMS receiver terminal 100 or in a user-setting menu. When the user of the MMS receiver terminal 100 selects the MMS receiving mode setting menu, the controller 260 displays the MMS receiving mode setting menu on the display unit 240. The MMS receiving mode includes at least one of an immediate retrieval mode, a deferred retrieval mode, and a preview retrieval mode so that the user may select one of the MMS receiving modes. The controller 260 sets the MMS receiving mode based on the input signal from the input unit 250. In this exemplary embodiment, it is assumed that the MMS receiving mode is set to a preview retrieval mode (305).

The MMS sender terminal 110 requests the MMS server 120 to transmit the MMS message (M-Send,req) (310). The MMS sender terminal 110 may directly create data included in the MMS message or may access a web server to select and transmit pre-generated content to the MMS server 120. The MMS server transmits a response indicating the reception of the request for the MMS message transmission to the MMS sender terminal 110 (M-Send.conf) (315). Then, the MMS server 120 transmits a notification message informing the MMS receiver terminal 100 of the arrival of the MMS message (M-Notification.ind) (320). In this case, the notification message includes at least a caller phone number, an ID, and header information of the MMS message excluding substantial data constituting the MMS message. The MMS server 120 may transmit the notification message in the SMS message type to the MMS receiver terminal 100. The MMS receiver terminal 100 confirms the MMS receiving mode setting (325). When the MMS receiving mode is set to the immediate retrieval mode, the MMS server 120 does not determine whether the user of the MMS receiver terminal 100 receives the MMS message but directly requests the transmission of the original MMS message (WSP/HTTP GET). When the MMS receiving mode is set to the deferred retrieval mode, the MMS receiver terminal 100 transmits a response to the notification message to the MMS server 120 (M-NotifyResp.ind) and displays a message for selecting whether to transmit the original MMS message on the display unit 240 (330). When the user requests transmission of the original MMS message, the MMS receiver terminal 100 requests the MMS server 120 to transmit the original MMS message (WSP/HTTP GET).

In the case that the MMS receiving mode is set to the preview retrieval mode, the

MMS receiver terminal 100 confirms that the MMS receiving mode is set to the preview retrieval mode (325), and the MMS receiver terminal 100 transmits the response to the notification message to the MMS server 120 and displays the message selecting whether to transmit the preview MMS message on the display unit 240.

When the MMS receiver terminal 100 confirms that the MMS receiving mode is set to the preview retrieval mode, the MMS receiver terminal 100 may directly request the MMS server 120 to transmit the MMS message. When the user requests transmission of the preview MMS message (335), the MMS receiver terminal 100 requests the MMS server 120 to transmit the preview MMS message (340). When the request for the transmission of the preview MMS message by the MMS receiver terminal 100 is confirmed, the MMS server 120 converts the original MMS message received from the MMS sender terminal 110 into a preview MMS message (345). The preview MMS message is differently converted according to file type and data type of data included in the original MMS message.

In a case when the data included in the original MMS message is a text file, the preview MMS message may be converted to include some of the content of the text file. For example, when a text file with 200 pages is included in the original MMS message, the preview MMS message may include only the first one or two pages.

When the data in the original MMS message is an image file, the preview MMS message may be converted into an MMS message of a smaller size than the original MMS message. The preview MMS message may be converted into an MMS message with a lower resolution than the original MMS message. For example, when the original MMS message includes image files in the form of JPG and BMP, the MMS server 120 converts the image files into small sized wireless bitmap (WBMP) file format images. When the original MMS message includes an image file having a resolution of 800×480, the MMS server 120 may convert the image file into an image file having a resolution of 176×144.

When the original MMS message includes an audio file, the preview MMS message may be converted into a format of smaller size and lower quality of sound than the original MMS message. For example, when the original MMS message includes an MP3 audio file, the MMS server 120 converts the MP3 audio file into a smaller sized MIDI or AMR format. When the original MMS message includes a 320 kbps audio file, the MMS server 120 may convert the audio file into a 128 kbps audio file. In this exemplary embodiment, the preview MMS message may include only a part of the entire running time of the original MMS message. For example, when the original MMS message includes a music file of 3 minutes 50 seconds running time, the preview MMS message may include only the first 10 seconds of the original music file.

When the original MMS message includes a video file, the preview MMS message may be a video file of a lower size and resolution than the video file of the original MMS message. For example, when the original MMS message includes a video file in WMF, ASF, or AVI format, the MMS server 120 may convert the video file included in the original MMS message into a low sized MP4 format file. When the original MMS message includes a moving picture having a resolution of 800*480, the MMS server 120 may convert the resolution of the moving picture to 176×144 resolution. In this exemplary embodiment, the preview MMS message may include a part of an entire running time of the original MMS message. For example, when the original MMS message includes a moving picture of 10 minutes and 11 seconds running time, the MMS server 120 converts the original MMS message to include only a part corresponding to the first one minute of the entire moving picture. In another exemplary embodiment, the preview MMS message may be a still image taken from images of the original MMS message. For example, when the original MMS message includes a moving picture of 10 minutes and 11 seconds running time, the MMS server 120 may generate image files of the preview MMS message by sampling images of the moving picture at one or more different sampling rates, e.g., 1 second, 1 minute and 20 seconds, 4 minutes and 50 seconds, 8 minutes and 34 seconds, and 10 minutes and 5 seconds.

In this exemplary embodiment, when the MMS server 120 receives a response to the notification message from the MMS receiver terminal 100 (330), the MMS server 120 may directly convert the original MMS message into the preview MMS message.

After the conversion of the original MMS message into the preview MMS message, the MMS server 120 transmits the preview MMS message in step 350 to the MMS receiver terminal 100 (M-retrieval.conf). The MMS receiver terminal 100 transmits a response to the transmission to the preview MMS message to the MMS server 120 (M-Acknowledge.ind) (355). The controller 260 of the MMS receiver terminal 100 outputs data included in the received preview MMS message on the display unit 240 and to the audio processor 250. After that, the controller 260 controls the display unit 240 to display a message allowing the user to determine whether to receive the original MMS message. When the user of the MMS receiver terminal 100 selects to receive the original MMS message (360), the controller 260 controls the wireless communication unit 210 to request the MMS server 120 to transmit the original MMS message (WSP/HTTP GET) (365). When the request for transmission of the original MMS message is received, the MMS server 120 converts the original MMS message received from the MMS sender terminal 110 into an original MMS message suitable for transmission to the receiver terminal 100. The original MMS message for transmission includes all data of the original MMS message received from the MMS sender terminal 110. However the MMS server 120 does not directly transmit the received original MMS message to the MMS receiver terminal 100. The MMS server 120 decodes the received original MMS message and encodes the received original MMS message to be transmittable to the MMS receiver terminal 100. The MMS server 120 transmits the original MMS message for transmission to the MMS receiver terminal 100 (M-retrieval.conf) (375). The MMS receiver terminal 100 transmits a response to the reception of the original MMS message to the MMS server 120 (M-Acknowledge.ind) (380). The MMS server 120 transmits a confirmation message to the request for the MMS message transmission to the MMS sender terminal 110 (M-Delivery.ind) (385).

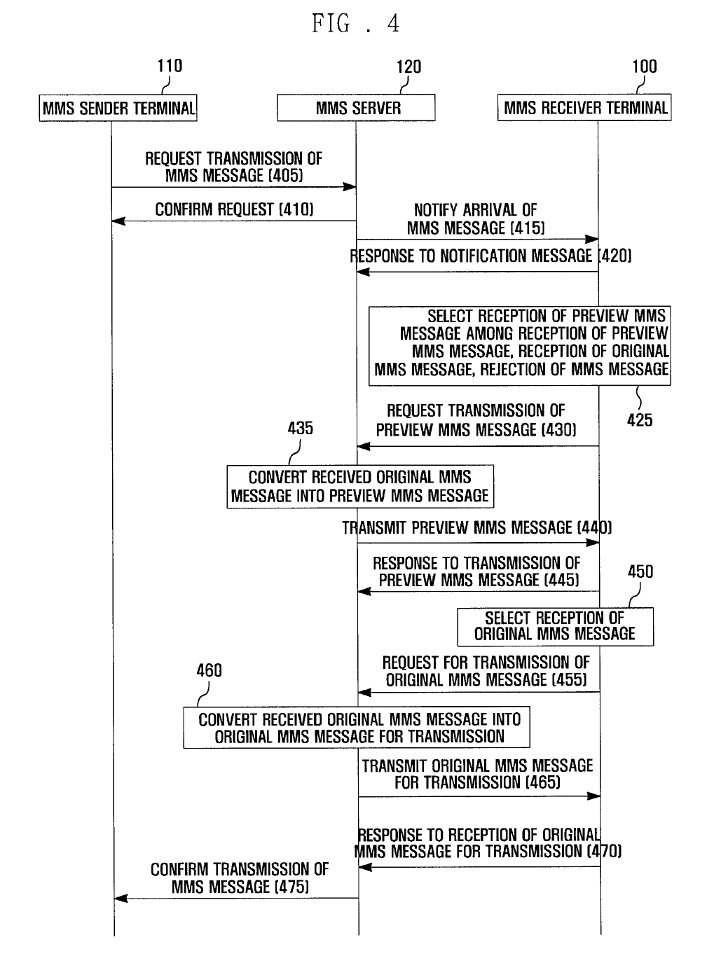

FIG. 4 is a sequence diagram illustrating a multimedia message transmitting and receiving method according to another exemplary embodiment of the present invention.

In another exemplary embodiment of the present invention, a multimedia message transmitting and receiving method wherein MMS receiving mode is not previously set will be described. The MMS sender terminal 110 sends a request to transmit an MMS message (M-Send.req) to the MMS server 120 (405). When the request for the transmission of the MMS message is received, the MMS server 120 transmits a response to the reception of the request for the transmission of the MMS message to the MMS sender terminal 110 (M-Send.conf) (410). After that, the MMS server 120 transmits a notification message notifying the MMS receiver terminal 100 of the reception of the MMS message to (M-Notification.ind) (415). The MMS receiver terminal 100 transmits to the MMS server 120 a response to the reception of the notification message for the MMS message (420). The controller 260 of the MMS receiver terminal 100 displays a message allowing the user to select any one of a reception of the original MMS message, a reception of the preview retrieval MMS message, and an MMS message rejection on the display unit 240 (425). The user may determine whether to receive the preview MMS message or the original MMS message after reception of the notification message even when the MMS receiving mode is not previously set. In this exemplary embodiment, it is assumed that the user selects the reception of the preview MMS message.

The MMS receiver terminal 100 requests the MMS server 120 to transmit the preview MMS message (WSP/HTTP GET) (430). When the request for the transmission of the preview MMS message by the MMS receiver terminal 100 is confirmed, the MMS server 120 converts the original MMS message received from the MMS sender terminal 110 into the preview MMS message (435). The conversion of the original MMS into the preview MMS message is the same as the conversion previously described. In another aspect of the invention, when a response to the notification message is received from the MMS receiver terminal 100 (420), the MMS server 120 may immediately convert the original MMS message into the preview MMS message.

After the conversion of the original MMS message into the preview MMS message, the MMS server 120 transmits the preview MMS message to the MMS receiver terminal 110 (M-retrieval.conf) (440). The MMS receiver terminal 100 transmits a response to the transmission of the preview MMS message to the MMS server 120 (M-Acknowledge.ind) (445). The controller 260 of the MMS receiver terminal 100 displays a message allowing the user to determine whether to receive the original MMS message on the display unit 260. When the user of the MMS receiver terminal 100 selects the reception of the original MMS message (450), the controller of the MMS receiver terminal 100 controls the wireless communication unit 210 to request the MMS server 120 to transmit the original MMS message (WSP/HTTP GET) (455). When the request for the transmission of the original MMS message is received, the MMS server 120 converts the original MMS message received from the MMS sender terminal 110 into an original MMS message suitable for transmission to the receiver terminal 100 and transmits the original MMS message to the MMS receiver terminal 100 (M-retrieval.conf) (465). The MMS receiver terminal 100 transmits a response to the reception of the original MMS message to the MMS server 120 (M-Acknowledge.ind) (470). The MMS server 120 transmits a confirmation message for the request for the transmission of the MMS message to the MMS sender terminal 110 (M-retrieval.ind) (475).

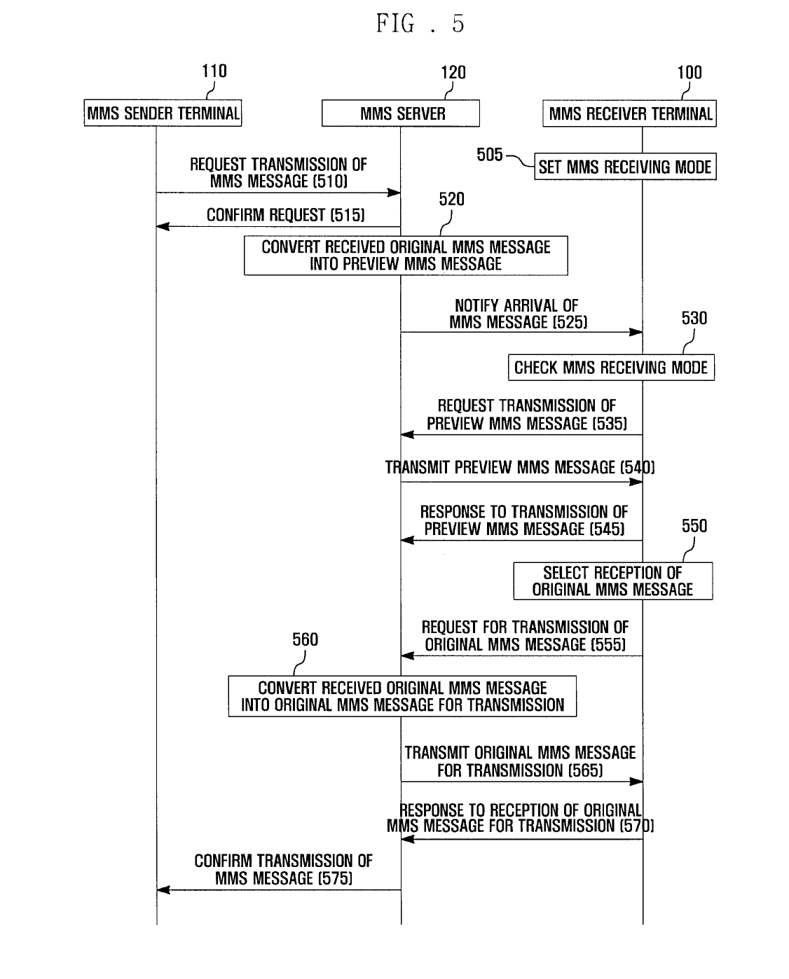

FIG. 5 is a sequence diagram illustrating a multimedia message transmitting and receiving method according to still another embodiment of the present invention.

In the multimedia message transmitting and receiving method according to this exemplary embodiment of the present invention, the conversion of an original MMS message into a preview MMS message starts earlier than the conversion performed in the processing shown in FIG. 4. In this exemplary process, the MMS receiver terminal 100 sets an MMS receiving mode (505). The MMS receiving mode may include an immediate retrieval mode, a deferred retrieval mode, and a preview retrieval mode. In this exemplary embodiment, it is assumed that the preview retrieval mode is set as the MMS receiving mode.

The MMS sender terminal 110 requests the MMS server 120 to transmit a MMS message (M-Send.req) (510). When the request for the transmission of the MMS message is received, the MMS server 120 transmits a response to the request for the transmission of the MMS message to the MMS sender terminal 110 (M-Send.conf) (515). Then, the MMS server 120 starts to convert the original MMS message received from the MMS sender terminal 110 into a preview MMS message (520). The description of the preview MMS message is the same as has been previously described and need not be repeated with regard to this exemplary embodiment. The MMS server 120 transmits the notification message to the MMS receiver terminal 100 notifying the receiver terminal 100 of the arrival of the MMS message. The MMS receiver terminal 100 checks the set MMS receiving mode (530). Then, the MMS receiver terminal 100 requests the MMS server 120 transmit the preview MMS message (WSP/HTTP GET) (535). In this exemplary embodiment, the MMS receiver terminal 100 may transmit a response to the notification message to the MMS server 120 and may request the MMS server 120 to transmit the preview MMS message when the user selects the reception of the preview MMS message (535).

When the request for the transmission of the preview MMS message by the MMS receiver terminal 100 is confirmed, the MMS server 120 transmits the preview MMS message to the MMS receiver terminal 10 (M-retrieval.conf) (540). The MMS receiver terminal 100 transmits a response to the transmission of the preview MMS message to the MMS server 120 (M-Acknowledge.ind) (545). The controller 260 of the MMS receiver terminal 100 displays a message allowing the user to determine whether to receive the original MMS message on the display unit 240. When the user of the MMS receiver terminal 100 selects the reception of the original MMS message, the controller 260 of the MMS receiver terminal 100 controls the wireless communication unit 210 to request the MMS server 120 to transmit the original MMS message (SWP/HTTP GET) (555). When the request for the transmission of the original MMS message is received, the MMS server 120 converts the original MMS message received from the MMS sender terminal 110 into an original MMS message suitable for transmission to the receiver terminal 100 (560). The MMS server 120 transmits the original MMS message to the MMS receiver terminal 100 (M-retrieval.conf) (565). The MMS receiver terminal 100 transmits a response to the reception of the original MMS message to the MMS server (M-Acknowledge.ind) (570). The MMS server 120 then transmits a confirmation message to the request for the transmission of the MMS message to the MMS sender terminal 110 (M-Delivery.ind) (575). In this still another embodiment, the starting point of the conversion of the preview MMS message is advanced so that the user of the MMS receiver terminal 100 may rapidly receive the preview MMS message.

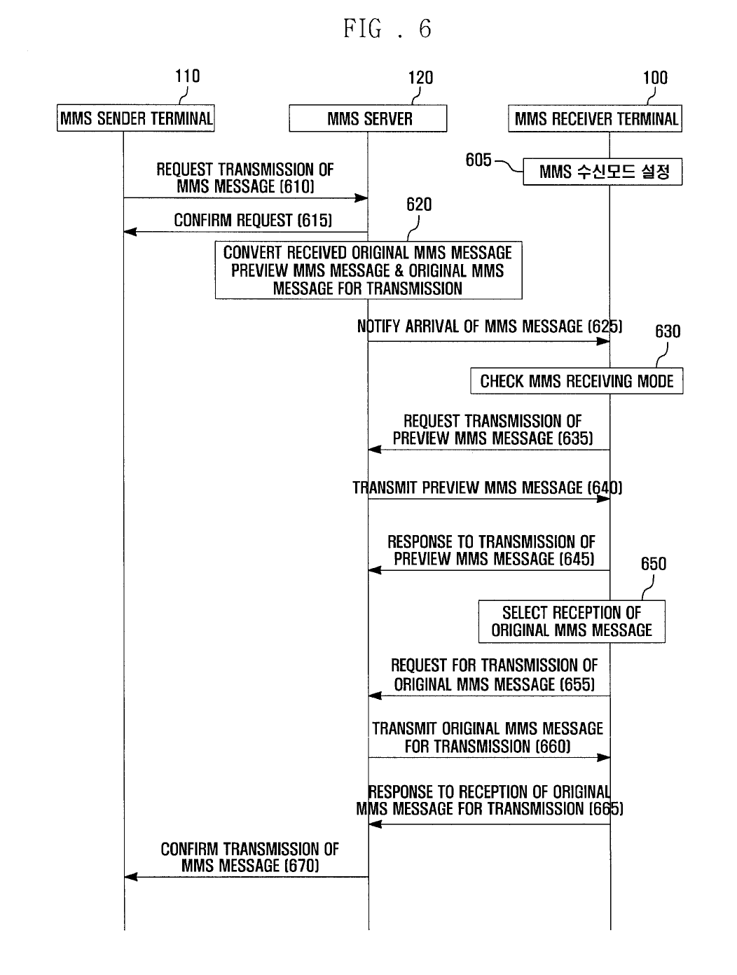

FIG. 6 is a sequence diagram illustrating a multimedia message transmitting and receiving method according to still another exemplary embodiment of the present invention.

In the multimedia message transmitting and receiving method according this exemplary embodiment of the present invention, conversion of an original MMS message into a preview MMS message and into an original MMS message suitable for transmission are performed at once. The MMS receiver terminal 100 sets an MMS receiving mode (605) and for the purposes of describing the subject matter of the invention, it is assumed that a preview retrieval mode is set as the MMS receiving mode.

The MMS sender terminal 110 requests the MMS server 120 to transmit an MMS message (M-Send.req) (610). When the request for the transmission of the MMS message is received, the MMS server 120 transmits a response to the request for the transmission of the MMS message to the MMS sender terminal 110 (M-Send.conf) (615). The MMS server 120 converts the original MMS message received from the MMS sender terminal 110 into a preview MMS message and an original MMS message suitable for transmission substantially concurrently (620). The description of the preview MMS message is the same as the description as previously described and need not be repeated again. The MMS server 120 nexts transmits a notification message to the MMS receiver terminal 100 notifying the receiver terminal 100 of the arrival of the MMS message (625). The MMS receiver terminal 100 confirms the MMS receiving mode (630). Then, the MMS receiver terminal 100 requests the MMS server 120 to transmit the preview MMS message (WSP/HTTP GET) (635). In this exemplary embodiment, when the MMS receiving mode is not set, the MMS receiver terminal 100 may display a message allowing selection of any one of reception of a preview MMS message, a reception of an original MMS message, and an MMS message rejection and may request transmission of the MMS message according to the user selection.

When the request for the transmission of the preview MMS message from the MMS receiver terminal 100 is confirmed, the MMS server 120 transmits the preview MMS message to the MMS receiver terminal 100 (M-retrieval.conf) (640). The MMS receiver terminal 100 transmits a response to the transmission of the preview MMS message to the MMS server 120 (M-Acknowledge.ind) (645). The controller 260 of the MMS receiver terminal 100 controls the display unit 240 to display a message allowing the user to determine whether to receive the original message. When the user of the MMS receiver terminal 100 selects the reception of the original MMS message (650), the controller 260 of the MMS receiver terminal 100 controls the wireless communication unit 210 to request the MMS server 120 to transmit the original MMS message (WSP/HTTP GET) (655). When the request for the transmission of the original MMS message is received, the MMS server 120 transmits the original MMS message suitable for transmission to the MMS receiver terminal 100 (M-retrieval.conf) (660). The MMS receiver terminal 100 transmits a response to the reception of the original MMS message to the MMS server 120 (M-Acknowledge.ind) (665). The MMS server 120 transmits a confirmation message to the request for the transmission of the MMS message to the MMS sender terminal 110 (M-Delivery.ind) (670). In still another embodiment of the present invention, the original MMS message received from the MMS sender terminal 110 is converted into the preview MMS message and the original MMS message suitable for transmission simultaneously so that the request from the MMS receiver terminal 100 can be actively managed.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A method of transmitting and receiving a multimedia message comprising:
transmitting, by a multimedia messaging service (MMS) server, a notification message notifying an MMS receiver terminal of an arrival of an MMS message when the MMS server receives at least one MMS message from an MMS sender terminal requesting the MMS server transmit a MMS message to the MMS receiver terminal;
converting the MMS message received from the MMS sender terminal into a preview MMS message by the MMS server; and
transmitting the preview MMS message to the MMS receiver terminal by the MMS server.

2. The method of claim 1, further comprising setting an MMS receiving mode to one of a group of: an immediate retrieval mode, a deferred retrieval mode, and a preview retrieval mode.

3. The method of claim 1, wherein, in converting the MMS message, the MMS server converts the MMS message received from the MMS sender terminal into a preview MMS message and an original MMS message suitable for transmission.

4. The method of claim 1, further comprising displaying a message requesting selection of one of: transmission of a preview MMS message, transmission of an original MMS message, and rejection of the MMS message by the MMS receiver terminal.

5. The method of claim 1, wherein in converting the MMS message, when the MMS message received from the MMS sender terminal is a text file, the MMS server converts the received MMS message into a preview MMS message including only a part of the text file.

6. The method of claim 1, wherein in converting the MMS message, when the MMS message received from the MMS sender terminal is one of an image, an audio file, and a video file, the MMS server converts the received MMS message into an MMS message in a smaller sized format than the received MMS message to generate the preview MMS message.

7. The method of claim 1, wherein in converting the MMS message, when the MMS message received from the MMS sender terminal is an image file or a moving picture, the MMS server converts the received MMS message into an MMS message with a lower resolution than the received MMS message to generate the preview MMS message.

8. The method of claim 1, wherein in converting the MMS message, when the MMS message received from the MMS sender terminal is an audio file or a moving picture, the MMS server coverts the received MMS message into the preview MMS message by sampling a part of an entire running time of the received MMS message.

9. The method of claim 1, wherein, in converting the MMS message, when the MMS message received from the MMS sender terminal is a moving picture, the MMS server captures some images of the received MMS message to generate the preview MMS message.

10. A method of transmitting and receiving a multimedia message comprising:
converting a multimedia messaging service (MMS) message received from an MMS sender terminal into a preview MMS message by an MMS server when at least one MMS messages is received from the MMS sender terminal;
transmitting a notification message to an MMS receiver terminal notifying the receiving terminal of an arrival of the MMS message by the MMS server;
requesting the MMS server to transmit the preview MMS message by the MMS receiver terminal; and
transmitting the preview MMS message to the MMS receiver terminal by the MMS server.

11. The method of claim 10, wherein, the MMS server converts the received MMS message into the preview MMS message and an original MMS message suitable for transmission.

12. A multimedia message transmitting and receiving system comprising:
a multimedia messaging service (MMS) terminal requesting transmission of an MMS message;
an MMS receiver terminal receiving the MMS message; and
an MMS server converting the MMS message received from the MMS sender terminal into a preview MMS message and transmitting the preview MMS message to the MMS receiver terminal when the request for the transmission of the MMS message is received from the MMS sender terminal.

13. The system of claim 12, wherein the MMS server converts the MMS message received from the MMS sender terminal into an original MMS message suitable for transmission and transmits the original MMS message suitable for transmission to the MMS receiver terminal when the request for the transmission of the MMS message is received from the MMS receiver terminal.

14. The system of claim 12, wherein the MMS server converts the MMS message received from the MMS sender terminal into the preview MMS message and an original MMS message for transmission simultaneously.

15. A receiving terminal comprising:
a processor in communication with a memory, the memory including code, which when accessed by the processor causes the processor to:
receiving a notification message of at least one MMS message;
responding to the notification message based on a mode of the receiving terminal; and
receiving an MMS message, wherein the MMS is at least one of: a preview message and an original MMS message.

16. The receiving terminal of claim 15, further comprising:
an input device in communication with the processor, the input device providing an input for setting the mode of the receiving terminal.

17. The receiving terminal of claim 15, further comprising:
an audio output device for providing an indication when the notification message is received.

18. The receiving terminal of claim 15, further comprising;
a display unit for displaying at least one of the notification message, the preview message and the original message.

19. The receiving terminal of claim 15, wherein the original MMS message is received after a preview message is received.

20. The receiving terminal of claim 19, wherein the original MMS message is received after selection by the user.
